(19) United States
(12) Patent Application Publication
(10) Pub. No.: US 2026/0230990 A1
(43) Pub. Date: Aug. 6, 2026

(54) METHODS AND APPARATUSES FOR A CHO WITH CANDIDATE SCGS FOR CPC/CPA PROCEDURE

(71) Applicant: Lenovo (Beijing) Limited, Beijing (CN)

(72) Inventors: Lianhai Wu, Beijing (CN); Shuigen Yang, Shanghai (CN); Le Yan, Shanghai (CN); Congchi Zhang, Shanghai (CN)

(73) Assignee: Lenovo (Beijing) Limited, Beijing (CN)

(21) Appl. No.: 19/152,331

(22) PCT Filed: May 10, 2023
(86) PCT No.: PCT/CN2023/093316

§ 371 Date: Jul. 30, 2025

(51) Int. Cl. H04W 36/36; H04W 36/00

(52) U.S. Cl. CPC H04W 36/362; H04W 36/00835

(57) ABSTRACT

Embodiments of the present application relate to methods and apparatuses for a conditional handover (CHO) with a candidate secondary cell groups (SCG)s for conditional primary secondary cell group cell (PSCell) change (CPC)/conditional PSCell addition (CPA) procedure. According to an embodiment of the present application, a user equipment (UE) includes a transceiver and a processor coupled to the transceiver; and the processor is configured to cause the UE to: receive radio resource control (RRC) configuration information for a CIIO with candidate secondary cell groups (SCG)s for conditional primary secondary cell group cell (PSCell) change (CPC)/conditional PSCell addition (CPA) procedure; and access the candidate PCell based on the RRC configuration information.

### TECHNICAL FIELD

Embodiments of the present application generally relate to wireless communication technology, in particular to methods and apparatuses for a conditional handover (CHO) with a candidate secondary cell groups (SCG)s for conditional primary secondary cell group cell (PSCell) change (CPC)/conditional PSCell addition (CPA) procedure.

### BACKGROUND

In a multi-radio dual connectivity (MR-DC) scenario, a UE with multiple transceivers may be configured to utilize resources provided by two different nodes connected via non-ideal backhauls. Wherein one node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, a Xn or X2 interface as specified in 3rd Generation Partnership Project (3GPP) standard documents), and at least the MN is connected to the core network.

Currently, a conditional PSCell addition (CPA) procedure and a conditional PSCell change (CPC) procedure are supported. A CPAC procedure may be a CPA procedure or a CPC procedure. According to agreements of 3GPP standard documents, a CPAC procedure is defined as a PSCell addition or a PSCell change that is executed by a UE when the configured CPAC execution condition(s) is met or fulfilled. A UE starts evaluating the CPAC execution condition(s) upon receiving CPAC related configuration information, and stops evaluating the CPAC execution condition(s) once a PSCell addition and/or change procedure is triggered or executed, the PSCell addition and/or change procedure is triggered or executed means that when CPAC execution condition(s) of a candidate PSCell is satisfied or fulfilled (“candidate PSCell” may also be named as “CPAC candidate PSCell”), the UE decides the candidate PSCell as a target PSCell, and executes a PSCell addition or change procedure with the target PSCell, e.g. the UE executes a RA procedure towards the target PSCell.

A CHO with candidate SCGs for CPC/CPA procedure may also be named as “a CHO with candidate SCG procedure”, or “a CHO including target MCG and candidate SCGs for CPC/CPA procedure”, or “a CHO including target MCG and candidate SCGs for CPA/CPC procedure,” or “a CHO with candidate SCGs procedure,” or “a CHO including target MCG and candidate SCGs procedure,” or “a CHO including candidate target MCG and candidate target SCGs for CPC/CPA procedure,” or “a CIIO including candidate target MCG and candidate target SCGs procedure,” or the like.

In a CHO with candidate SCGs for CPC/CPA procedure, when a UE receives configuration(s) for the CHO including target MCG and candidate SCGs for CPC/CPA procedure (i.e. CHO configuration(s) referring to or including CPC or CPA configuration, or configuration(s) for a CHO with candidate SCGs procedure), e.g. when the UE receives configuration for CHO candidate (target) PCell(s), CHO execution condition(s), configuration for CPAC candidate (target) PSCell(s) and CPAC execution condition(s), the CHO evaluation and the CPC or CPA evaluation may be concurrent. For example, the UE starts evaluation of CHO execution condition(s) for candidate (target) PCells and CPAC execution condition(s) for candidate (target) PSCells at the same time (when receiving the configuration for a CHO with candidate SCGs procedure). The UE doesn't execute CPC or CPA unless CHO execution condition(s) of a CHO candidate PCell is fulfilled.

Currently, details regarding simultaneous execution of PCell/PSCell change and an MRO mechanism for a CHO with candidate SCGs for CPC/CPA procedure (i.e. a CHO with candidate SCG procedure) have not been discussed yet.

### SUMMARY

Some embodiments of the present application provide a user equipment (UE). The UE includes a transceiver and a processor coupled to the transceiver; and the processor is configured to cause the UE to: receive first radio resource control (RRC) configuration information for a CHO with candidate secondary cell groups (SCG)s for conditional primary secondary cell group cell (PSCell) change (CPC)/conditional PSCell addition (CPA) procedure; and access the candidate PCell based on the first RRC configuration information.

In some embodiments, the first RRC configuration information includes: a first CHO configuration related to a candidate primary cell (PCell); a first CHO execution condition for the candidate PCell; configuration information for one or more candidate SCGs associated with one or more candidate PSCells; and a set of execution conditions for the one or more candidate SCGs.

In some embodiments, the processor is configured to cause the UE to receive second RRC configuration information for a second CHO configuration without candidate SCG.

In some embodiments, a second CHO execution condition is configured for the second CHO configuration.

In some embodiments, the second RRC configuration information includes a first indication indicating an association relationship between the second CHO configuration and the first CHO configuration.

In some embodiments, in response to receiving the first indication, the processor is configured to cause the UE to consider that a second CHO execution condition for the second CHO configuration is the same as the first CHO execution condition for the candidate PCell.

In some embodiments, in response to fulfillment of both the second CHO execution condition for the second CHO configuration and the first CHO execution condition for the first CHO configuration, the processor is configured to cause the UE to: in response to fulfillment of the set of execution conditions for one candidate SCG within the one or more candidate SCGs, execute a CHO based on the first CHO configuration to both the candidate PCell and one candidate PSCell associated with the one candidate SCG; or in response to unfulfillment of the set of execution conditions for the one or more candidate SCGs, execute a CHO based on the second CHO configuration to the candidate PCell.

In some embodiments, the processor is configured to cause the UE to receive: a second indication indicating that a CHO is allowed to be executed by the UE based on a second CHO configuration without candidate SCG; or a third indication indicating that the second CHO configuration without candidate SCG related to the candidate PCell is the same as the first CHO configuration related to the candidate PCell.

In some embodiments, in response to receiving the second indication or the third indication, the processor is configured to cause the UE to consider that the second CHO configuration is the same as the first CHO configuration.

In some embodiments, in response to unfulfillment of the set of execution conditions for the one or more candidate SCGs and fulfillment of the first CHO execution condition, the processor is configured to cause the UE to access the candidate PCell based on the second CHO configuration.

In some embodiments, after successfully accessing the candidate PCell based on the second CHO configuration, the processor is configured to cause the UE to: release one or more SCG bearers configured in the one or more candidate SCGs; or re-map the one or more SCG bearers to a master cell group (MCG) bearer configured in the candidate PCell.

In some embodiments, the processor is configured to cause the UE to: execute a CHO based on the first CHO configuration or the second CHO configuration; and after successfully accessing the candidate PCell, transmit an RRC reconfiguration complete message to the candidate PCell.

In some embodiments, the RRC reconfiguration complete message includes an indication indicating that the UE has executed a CHO based on which one of the first CHO configuration and the second CHO configuration.

In some embodiments, the RRC reconfiguration complete message includes at least one of: an identifier (ID) of the candidate PCell accessed by the UE; or an ID of a candidate PSCell accessed by the UE.

In some embodiments, in response to fulfillment of a trigger condition, the processor is configured to cause the UE to transmit both a successful handover report (SHR) and a successful PSCell change report (SPCR) to a target network node.

In some embodiments, the processor is configured to cause the UE to receive a threshold related to the trigger condition from a source network node, and wherein the threshold is: a first threshold associated with a timer for initiating failure recovery based on triggering measurement report; or a second threshold associated with a physical layer problem timer; or a third threshold associated with a handover timer.

In some embodiments, the threshold is a percent value of a timer length.

In some embodiments, the trigger condition includes at least one of: an elapsed time duration of the timer for initiating failure recovery based on triggering measurement report exceeds the first threshold multiplied by a length of the timer for initiating failure recovery based on triggering measurement report; an elapsed time duration of the physical layer problem timer exceeds the second threshold multiplied by a length of the physical layer problem timer; or an elapsed time duration of the handover timer exceeds the third threshold multiplied by a length of the handover timer.

In some embodiments, the SHR and the SPCR are included in a UE information response message.

In some embodiments, in response to fulfillment of the set of execution conditions of multiple SCGs within the one or more candidate SCGs, the UE information response message further includes ID information of other SCGs within the multiple SCGs except one SCG accessed by the UE.

Some embodiments of the present application provide a source network node. The source network node includes a transceiver and a processor coupled to the transceiver; and the processor is configured to cause the source network node to: transmit a handover request for a CHO; and receive a response from a candidate network node, wherein the response includes: a first CHO configuration related to a candidate primary cell (PCell); and configuration information for one or more candidate SCGs associated with one or more candidate PSCells.

In some embodiments, the response includes a set of execution conditions for the one or more candidate SCGs.

In some embodiments, the processor is configured to cause the source network node to receive an indication from the candidate network node, wherein the indication indicates that a second CHO configuration related to the candidate PCell is the same as the first CHO configuration related to the candidate PCell.

In some embodiments, the indication is included in a handover request acknowledge message.

In some embodiments, the processor is configured to cause the source network node to transmit the indication to the UE.

In some embodiments, the processor is configured to cause the source network node to transmit a threshold related to a trigger condition to a user equipment (UE), and wherein the trigger condition is for triggering simultaneous transmission of both a successful handover report (SHR) and a successful PSCell change report (SPCR).

In some embodiments, the threshold is a percent value of a timer length.

In some embodiments, the threshold is: a first threshold associated with a timer for initiating failure recovery based on triggering measurement report; or a second threshold associated with a physical layer problem timer; or a third threshold associated with a handover timer.

In some embodiments, the trigger condition includes at least one of: an elapsed time duration of the timer for initiating failure recovery based on triggering measurement report exceeds the first threshold multiplied by a length of the timer for initiating failure recovery based on triggering measurement report; an elapsed time duration of the physical layer problem timer exceeds the second threshold multiplied by a length of the physical layer problem timer; or an elapsed time duration of the handover timer exceeds the third threshold multiplied by a length of the handover timer.

Some embodiments of the present application provide a candidate network node. The candidate network node includes a transceiver and a processor coupled to the transceiver; and the processor is configured to cause the candidate network node to: receive a handover request for a CHO from a source network node; and transmit a response to the source network node, wherein the response includes: a first CHO configuration related to a candidate primary cell (PCell); and configuration information for one or more candidate SCGs associated with one or more candidate PSCells.

In some embodiments, the response includes a set of execution conditions for the one or more candidate SCGs.

In some embodiments, the processor is configured to cause the candidate network node to transmit an indication to the source network node, and wherein the indication indicates that a second CHO configuration related to the candidate PCell is the same as the first CHO configuration related to the candidate PCell.

In some embodiments, the processor is configured to cause the candidate network node to receive both a successful handover report (SHR) and a successful PSCell change report (SPCR) from a user equipment (UE), and wherein the SHR and the SPCR are simultaneously transmitted by the UE in response to fulfillment of a trigger condition.

In some embodiments, the trigger condition includes at least one of: an elapsed time duration of a timer for initiating failure recovery based on triggering measurement report exceeds a first threshold multiplied by a length of the timer for initiating failure recovery based on triggering measurement report; an elapsed time duration of a physical layer problem timer exceeds a second threshold multiplied by a length of the physical layer problem timer; or an elapsed time duration of a handover timer exceeds a third threshold multiplied by a length of the handover timer.

In some embodiments, each of the first threshold, the second threshold, and the third threshold is a percent value of a timer length.

In some embodiments, the SHR and the SPCR are included in a UE information response message.

In some embodiments, in response to fulfillment of the set of execution conditions of multiple SCGs within the one or more candidate SCGs, the UE information response message further includes identifier (ID) information of other SCGs within the multiple SCGs except one SCG accessed by the UE.

Some embodiments of the present application provide a method, which may be performed by a UE. The method includes: receiving first radio resource control (RRC) configuration information for a CHO with candidate secondary cell groups (SCG)s for conditional primary secondary cell group cell (PSCell) change (CPC)/conditional PSCell addition (CPA) procedure; and accessing the candidate PCell based on the first RRC configuration information.

Some embodiments of the present application provide a method, which may be performed by a source network node. The method includes: transmitting a handover request for a CHO; and receiving a response from a candidate network node, wherein the response includes: a first CHO configuration related to a candidate primary cell (PCell); and configuration information for one or more candidate SCGs associated with one or more candidate PSCells.

Some embodiments of the present application provide a method, which may be performed by a candidate network node. The method includes: receiving a handover request for a CHO from a source network node; and transmitting a response to the source network node, wherein the response includes: a first CHO configuration related to a candidate primary cell (PCell); and configuration information for one or more candidate SCGs associated with one or more candidate PSCells.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE, a source network node, or a candidate network node.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary UE information procedure in accordance with some embodiments of the present application.

FIG. 3 illustrates an exemplary flowchart of accessing a candidate PCell in accordance with some embodiments of the present application.

FIG. 4 illustrates an exemplary flowchart of transmitting a handover request in accordance with some embodiments of the present application.

FIG. 5 illustrates an exemplary flowchart of receiving a handover request in accordance with some embodiments of the present application.

FIGS. 6-8 illustrate exemplary flowcharts related to a CHO with candidate SCG procedure in accordance with some embodiments of the present application.

FIG. 9 illustrates an exemplary block diagram of an apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application.

As illustrated and shown in FIG. 1, a wireless communication system 100 includes at least one UE 101 and at least one BS 102. In particular, the wireless communication system 100 includes one UE 101 (e.g. UE 101a) and three BSs 102 (e.g. BS 102a, BS 102b, and BS 102c) for illustrative purpose. Although a specific number of UEs 101 and BSs 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g. televisions connected to the Internet), set-top boxes, game consoles, security systems (including security cameras), vehicle on-board computers, network devices (e.g. routers, switches, and modems), internet of things (IoT) devices, or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via uplink (UL) communication signals.

In some embodiments of the present application, each of UE(s) 101 may be deployed an IoT application, an eMBB application and/or an URLLC application. It is contemplated that the specific type of application(s) deployed in UE(s) 101 may be varied and not limited.

BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of transmitting and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G of the 3GPP protocol, wherein BS(s) 102 transmit data using an OFDM modulation scheme on the downlink (DL) and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

Each BS(s) 102 may include one or more cells. Each UE(s) 101 may execute a cell section procedure between different cell(s) of different BS(s). Each UE(s) 101 may handover from a serving cell of a source BS to a target cell of a target BS. For example, in the wireless communication system 100 as illustrated and shown in FIG. 1, BS 102a may function as a source BS, and each of BS 102b and BS 102c may function as a target BS. If there is a handover need, UE 101a as illustrated and shown in FIG. 1 may execute a handover procedure from a serving cell of BS 102a to a target cell of BS 102b or a target cell of BS 102c, which depends a result of a cell selection procedure. The handover procedure executed by UE 101a may be a CHO procedure.

As specified in 3GPP standard documents, CHO is defined as a handover that is executed by a user equipment (UE) when one or more CHO execution conditions are met. The UE starts evaluating the one or more CHO execution conditions upon receiving the CHO related configuration information (e.g. including one or more configurations associated with candidate PCell(s) and one or more CHO execution conditions), and stops evaluating the CHO execution conditions during the CHO execution or once the one or more CHO execution conditions are met or fulfilled. The CHO execution means that when CHO execution condition(s) of a candidate PCell is satisfied or fulfilled (“candidate PCell” may also be named as “CHO candidate PCell”), the UE decides the candidate PCell as a target PCell, and executes a PCell change or handover procedure with the target PCell, e.g. the UE executes a RA procedure towards the target PCell.

Mobility Robustness Optimization (MRO) is to detect connection failures that occur due to Too Early or Too Late Handovers, or Handover to Wrong Cell. The general procedure is that after RLF/HO failure happen, UE access new cell by re-establishment or connection setup. Once UE enters connected state, UE transmits RLF report and RACH report to the serving cell. The serving cell will transmit Failure Indication including RLF report to the last serving cell. Finally, the information is used to optimize the mobility. One of the functions of Mobility Robustness Optimization is to detect connection failures that occur due to Too Early or Too Late Handovers, or Handover to Wrong Cell.

Generally, in a UE information procedure, after a RLF or a HO failure occurs, a UE may execute an RRC re-establishment procedure in a cell. The UE will store some information related with the RLF failure and/or the HO failure. The UE stores the latest RLF Report, including both LTE and NR RLF report until the RLF report is fetched by the network or for 48 hours after the connection failure is detected. For analysis of connection failure(s), the UE makes the RLF report available to the network.

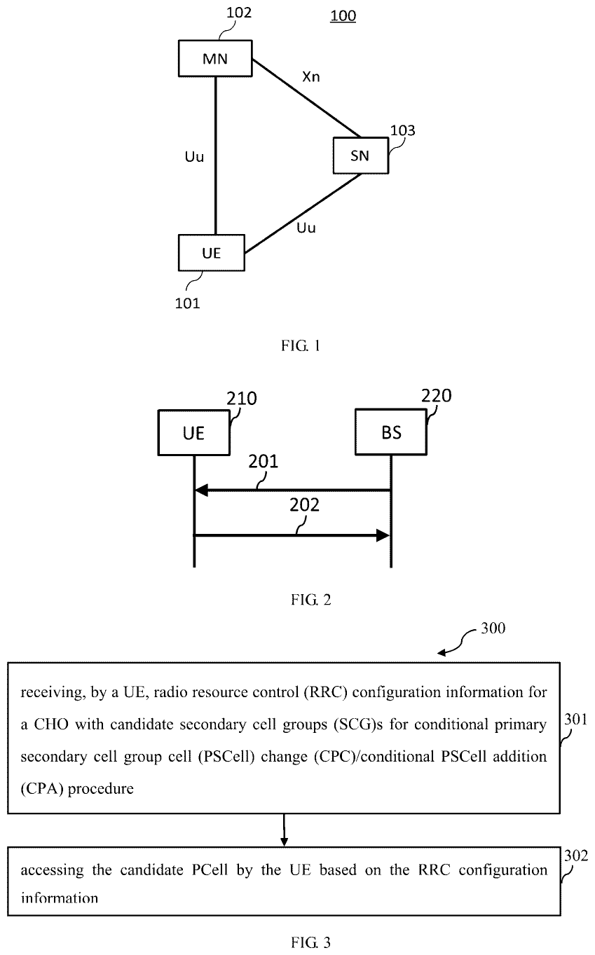

FIG. 2 illustrates an exemplary UE information procedure in accordance with some embodiments of the present application. The embodiments of FIG. 2 show a procedure of a UE (e.g. UE 210) communicating with a BS (e.g. BS 220). In some examples, UE 210 may function as UE 101a in FIG. 1. BS 220 may function as BS 102a, BS 102b, or BS 102c in FIG. 1.

As shown in FIG. 2, in operation 201, BS 220 (e.g. BS 102a as illustrated and shown in FIG. 1) transmits UE Information Request message to UE 210 (e.g. UE 101a as illustrated and shown in FIG. 1). BS 220 may be a source BS which controls a serving cell of UE 210. In operation 202, US 210 transmits UE Information Response message including a RLF report to BS 220. BS 220 can optimize a mobility problem based on the response transmitted from UE 210.

In 3GPP Rel-17, Successful Handover Report (SHR) is introduced for MRO of a PCell change procedure. The PCell change may be a legacy PCell change or a handover or a conditional PCell change or a condition handover (CHO). In particular, a MRO function in NR could be enhanced to provide a more robust mobility via reporting failure events observed during successful handovers from source NG-RAN to target NG-RAN by a SHR. A SHR is a report associated with a successful handover comprising a set of measurements collected during the handover phase, i.e., measurement at the handover trigger, measurement at the end of handover execution or measurement after handover execution. For example, a UE could store successful PCell change related information or generates the VarSuccessHO-Report/SHR when at least one of the following trigger conditions is satisfied and/or RA to PCell is successful:
(1) The ratio between the value of the elapsed time of the timer T310 of source PCell and the configured value of the timer T310 configured for source PCell while the UE was connected to the source PCell before executing the last PCell change/HO procedure, is greater than a configured threshold (e.g. thresholdPercentageT310 configured by the source PCell before executing the last PCell change/HO procedure).
(2) If the T312 associated with the measurement identity of the target PCell was running at the time of initiating the execution of the PCell change/HO procedure, and if the ratio between the value of the elapsed time of the timer T312 and the configured value of the timer T312 (which is configured while the UE was connected to the source PCell before executing the last PCell change/HO procedure), is greater than a configured threshold (e.g. thresholdPercentageT312 configured by the source PCell before executing the last PCell change/HO procedure).
(3) The ratio between the value of the elapsed time of the elapsed timer T304 of target PCell and the configured value of the timer T304 (i.e., which is included in the last applied RRCReconfiguration message including the reconfigurationWithSync for PCell change/HO procedure), is greater than a configured threshold (e.g. thresholdPercentageT304 configured by the target PCell before executing the last PCell change/HO procedure).

Successful PCell change related information is included in a SHR, for example, at least one of: cell information of the source PCell, cell information of the target PCell, cause value for SHR (e.g. t304-cause, t310-cause, or t312-cause), measurement results of source PCell and/or target PCell when HO is executed or successful, and RA information (e.g. RACH configurations for target PCell). In general, cell information includes global cell identity and tracking area code of the cell, or PCI and frequency information (e.g. ARFCN).

The availability of a SHR may be indicated by the Handover Complete message (RRCReconfigurationComplete) transmitted from UE to target NG-RAN node over RRC. The target NG-RAN node may fetch information of a successful handover report via UE Information Request/Response mechanism. In addition, the target NG-RAN node could then forward the SHR to the source NR-RAN node to indicate failures experienced during a successful handover event.

Upon reception of a SHR, the receiving node is able to analyse whether its mobility configuration needs adjustment. Such adjustments may result in changes of mobility configurations, such as changes of RLM configurations or changes of mobility thresholds between the source and the target. In addition, target NG-RAN node, in the executed handover, may further optimize the dedicated RACH resources based on the measurements reported upon successful handovers.

In 3GPP Rel-18, a successful PSCell change report (SPCR) would be introduced, to optimize PSCell change or CPAC related parameters, e.g. if a physical layer issue is detected by a UE during an ongoing legacy PSCell change procedure or an ongoing CPAC procedure. For reporting a SPCR, configurations for the UE to log or generate the SPCR (e.g. successPSCellChange-Config IE (information element)) is configured by a network, e.g. via an RRCReconfiguration message, including timer T304 related threshold (a threshold e.g. thresholdPercentageT304 generated by a target PSCell), timer T310 related threshold (a threshold e.g. thresholdPercentageT310 generated by a source PSCell or a source PCell), or timer T312 related threshold (a threshold e.g. thresholdPercentageT312 generated by a source PSCell or a source PCell). Based on the network configuration, the UE needs to log or generate successful PSCell change related parameters when at least one trigger condition is satisfied. A SPCR can be generated and reported to the network, including cell global identifier (CGI) information of the source PSCell, CGI information of the target PSCell, cause value for successful PSCell change report (e.g. t304-cause, t310-cause, or t312-cause), and measurement results.

A CHO without candidate SCG may also be named as “a CHO-only” or the like. Currently, there may be the following two scenarios:
(1) Use case #1: CHO configuration(s) of a CHO with candidate SCG procedure and CHO configuration(s) of a CHO without candidate SCG (i.e. CHO-only) are configured separately. In this scenario, CHO execution condition(s) of the CHO with candidate SCG procedure and the CHO-only could be the same or different.
(2) Use case #2: CHO configuration(s) of a CHO without candidate SCG (i.e. CHO-only) is the same as CHO configuration(s) (i.e. the CHO Part) from a CHO with candidate SCG procedure.

However, the following issues need to be solved: how to ensure a CHO with candidate SCG procedure can be executed in priority in use case #1; how to realize use case #2; how to realize some enhancements to use case #2; what is an enhanced trigger condition for successful CHO and CPC procedure; and in the case of a CHO with candidate SCG procedure, what additional information should be reported.

Embodiments of the present application aim to solve the abovementioned issues. For example, some embodiments of the present application provide mechanisms for use case #1 and use case #2. Some embodiments of the present application provide mechanisms for simultaneous execution of PCell/PSCell change in a CHO with candidate SCG procedure. Some embodiments of the present application provide a MRO mechanism for a CHO with candidate SCG procedure. More details will be illustrated in the following text in combination with the appended drawings.

FIG. 3 illustrates an exemplary flowchart of accessing a candidate PCell in accordance with some embodiments of the present application. The exemplary flowchart 300 may be executed by a UE (e.g. UE 101, UE 601, UE 701, or UE 801 as shown and illustrated in any of FIGS. 1 and 6-8). Although described with respect to a UE, it should be understood that other devices may also be configured to perform the exemplary flowchart as shown and illustrated in FIG. 3.

In the exemplary flowchart 300 as shown in FIG. 3, in operation 301, a UE may receive RRC configuration information for a CHO with candidate SCGs for CPC/CPA procedure (i.e. a CHO with candidate SCG procedure). In operation 302, the UE may access the candidate PCell based on the RRC configuration information.

For instance, the RRC configuration information may be included in an RRC reconfiguration message. In some embodiments, the RRC configuration information may include:
(1) a CHO configuration related to a candidate PCell (denoted as CHO configuration #1 for simplicity);
(2) a CHO execution condition for the candidate PCell (denoted as CHO execution condition #1);
(3) configuration information for one or more candidate SCGs associated with one or more candidate PSCells; and
(4) a set of execution conditions for the one or more candidate SCGs.

In some embodiments of the exemplary flowchart 300, for example, in use case #1, the UE may receive additional RRC configuration information for a CHO configuration without candidate SCG (i.e. CHO configuration of CHO-only; and denoted as CHO configuration #2). For instance, the additional RRC configuration information and the RRC configuration information in operation 301 may be included in the same RRC reconfiguration message or different RRC reconfiguration messages.

In an embodiment, a CHO execution condition (denoted as CHO execution condition #2) may be configured for CHO configuration #2. For instance, time to trigger (TTT) for CHO execution condition #2 could be larger than TTT for CHO execution condition #1.

In an embodiment, the additional RRC configuration information includes an indication (denoted as indication #1) which indicates an association relationship between CHO configuration #2 and CHO configuration #1. For instance, indication #1 may indicates that CHO configuration #2 is a complementary for CHO configuration #1. A specific example is described in the embodiments of FIG. 6.

In some embodiments of the exemplary flowchart 300, if indication #1 is received, the UE may consider that CHO execution condition #2 for CHO configuration #2 is the same as CHO execution condition #1 for the candidate PCell. Thus, the specific configuration of CHO execution condition #2 can be avoided.

In some embodiments of the exemplary flowchart 300, if both CHO execution condition #2 for CHO configuration #2 (e.g. for CHO-only) and CHO execution condition #1 for CHO configuration #1 (e.g. for a CHO with candidate SCG procedure) are fulfilled, the UE may:
(1) if the set of execution conditions for one candidate SCG within the one or more candidate SCGs is fulfilled, execute a CHO based on CHO configuration #1 to both “the candidate PCell” and “one candidate PSCell associated with the one candidate SCG”; or
(2) if the set of execution conditions for the one or more candidate SCGs is not fulfilled, execute a CHO based on CHO configuration #2 to the candidate PCell.

In some embodiments of the exemplary flowchart 300, for example, in use case #2, the UE may receive an indication (denoted as indication #2) which indicates that a CHO is allowed to be executed by the UE based on a CHO configuration without candidate SCG (e.g. CHO configuration #2). In some embodiments, the UE may receive an indication (denoted as indication #3) which indicates that a CHO configuration without candidate SCG (e.g. CHO configuration #2) related to the candidate PCell is the same as CHO configuration #1 related to the candidate PCell. In some embodiments, the UE may receive both indication #2 and indication #3.

In an embodiment, if indication #2 and/or indication #3 are received, e.g. via Uu interface, the UE may consider that the CHO configuration without candidate SCG (e.g. CHO configuration #2) is the same as CHO configuration #1 related to the candidate PCell (e.g. for a CHO with candidate SCG procedure).

In an embodiment, if the set of execution conditions for the one or more candidate SCGs is not fulfilled and CHO execution condition #1 is fulfilled, the UE may access the candidate PCell based on CHO configuration #2. After successfully accessing the candidate PCell (i.e. a target PCell) based on CHO configuration #2, the UE may release one or more SCG bearers configured in the one or more candidate SCGs, or the UE may re-map the one or more SCG bearers to a MCG bearer configured in the candidate PCell.

According to some embodiments of the exemplary flowchart 300, the UE may execute a CHO based on CHO configuration #1 or CHO configuration #2. After successfully accessing the candidate PCell (i.e. a target PCell), the UE may transmit an RRC reconfiguration complete message to the candidate PCell. In an embodiment, the RRC reconfiguration complete message includes an indication indicating that the UE has executed a CHO based on which one of CHO configuration #1 and CHO configuration #2.

In an embodiment, the RRC reconfiguration complete message includes at least one of: an ID of the candidate PCell accessed by the UE; or an ID of a candidate PSCell accessed by the UE. For example, if the UE has executed a CHO based on CHO configuration #2, the RRC reconfiguration complete message may include the ID of the candidate PCell. If the UE has executed a CHO based on CHO configuration #1, the RRC reconfiguration complete message includes both the ID of the candidate PCell and the ID of the candidate PSCell. Specific examples are described in the embodiments of FIG. 7.

In some embodiments of the exemplary flowchart 300, in response to fulfillment of a trigger condition, the UE may transmit both a successful handover report (SHR) and a successful PSCell change report (SPCR) to a target network node. In an embodiment, the SHR and the SPCR are included in a UE information response message. For instance, if the set of execution conditions of multiple SCGs within one or more candidate SCGs is fulfilled, the UE may select one SCG from the multiple SCGs, and execute the CHO with candidate SCGs for CPC/CPA procedure to access the one SCG. If the set of execution conditions of the multiple SCGs is fulfilled, the UE information response message may also include ID information of other SCGs within the multiple SCGs except the one SCG accessed by the UE. Specific examples are described in the embodiments of FIG. 8.

In an embodiment, the UE may receive a threshold related to the trigger condition from a source network node. The threshold may be a percent value of a timer length. For instance, the threshold may be:
(1) a threshold (denoted as threshold #1) associated with a timer for initiating failure recovery based on triggering measurement report (e.g. timer T312); or
(2) a threshold (denoted as threshold #2) associated with a physical layer problem timer (e.g. timer T310); or
(3) a threshold (denoted as threshold #3) associated with a handover timer (e.g. timer T304).

In some embodiments, the trigger condition includes at least one of:
(1) an elapsed time duration of the timer for initiating failure recovery based on triggering measurement report (e.g. timer T312) exceeds threshold #1 multiplied by a length of the timer for initiating failure recovery based on triggering measurement report (e.g. timer T312);
(2) an elapsed time duration of the physical layer problem timer (e.g. timer T310) exceeds threshold #2 multiplied by a length of the physical layer problem timer (e.g. timer T310); or
(3) an elapsed time duration of the handover timer (e.g. timer T304) exceeds threshold #3 multiplied by a length of the handover timer (e.g. timer T304).

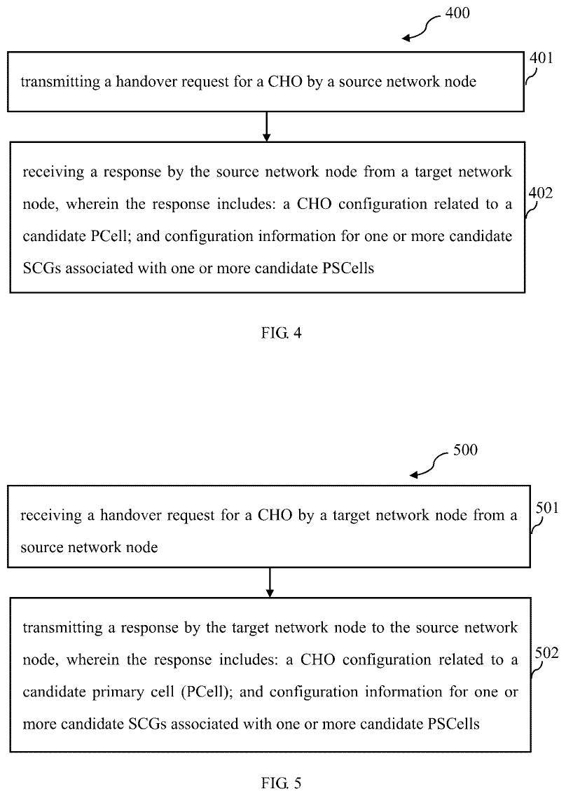

FIG. 4 illustrates an exemplary flowchart of transmitting a handover request in accordance with some embodiments of the present application. The exemplary flowchart 400 may be performed by a source network node (e.g. source gNB, source BS 602, source BS 702, or source BS 802 as shown and illustrated in any of FIGS. 1 and 6-8). Although described with respect to a source network node, it should be understood that other devices may also be configured to perform the exemplary flowchart as shown and illustrated in FIG. 4.

In the exemplary flowchart 400 as shown in FIG. 4, in operation 401, a source network node may transmit a handover request for a CHO. In operation 402, the source network node may receive a response from a candidate network node (e.g. candidate gNB or target gNB). The response may include at least one of the following:
(1) a CHO configuration related to a candidate PCell (e.g. CHO configuration #1 described in the exemplary flowchart 300);
(2) configuration information for one or more candidate SCGs associated with one or more candidate PSCells; or
(3) a set of execution conditions for the one or more candidate SCGs.

In some embodiments of the exemplary flowchart 400, the source network node may receive an indication (denoted as indication #4) from the candidate network node, e.g. via Xn interface. Indication #4 may indicate that another CHO configuration (e.g. CHO configuration #2 described in the exemplary flowchart 300) related to the candidate PCell is the same as the CHO configuration related to the candidate PCell in operation 402, or indicate that CHO-only configuration(s) from the CHO configuration(s) with candidate SCG(s) can be executed. In an embodiment, indication #4 is included in a handover request acknowledge message. For instance, the source network node may further transmit a similar indication (e.g. indication #3 described in the exemplary flowchart 300) to the UE. Specific examples are described in the embodiments of FIG. 7.

In some embodiments of the exemplary flowchart 400, the source network node may transmit a threshold related to a trigger condition to a UE (e.g. UE 101, UE 601, UE 701, or UE 801 as shown and illustrated in any of FIGS. 1 and 6-8). The trigger condition is for triggering simultaneous transmission of both a SHR and a SPCR. The threshold may be a percent value of a timer length. Specific examples are described in the embodiments of FIG. 8.

According to some embodiments, the threshold is:
(1) a threshold (e.g. threshold #1 described in the exemplary flowchart 300) associated with a timer for initiating failure recovery based on triggering measurement report (e.g. timer T312); or
(2) a threshold (e.g. threshold #2 described in the exemplary flowchart 300) associated with a physical layer problem timer (e.g. timer T310); or
(3) a threshold (e.g. threshold #3 described in the exemplary flowchart 300) associated with a handover timer (e.g. timer T304).

According to some embodiments, the trigger condition includes at least one of:
(1) an elapsed time duration of the timer for initiating failure recovery based on triggering measurement report (e.g. timer T312) exceeds threshold #1 multiplied by a length of the timer for initiating failure recovery based on triggering measurement report (e.g. timer T312);
(2) an elapsed time duration of the physical layer problem timer (e.g. timer T310) exceeds threshold #2 multiplied by a length of the physical layer problem timer (e.g. timer T310); or
(3) an elapsed time duration of the handover timer (e.g. timer T304) exceeds threshold #3 multiplied by a length of the handover timer (e.g. timer T304).

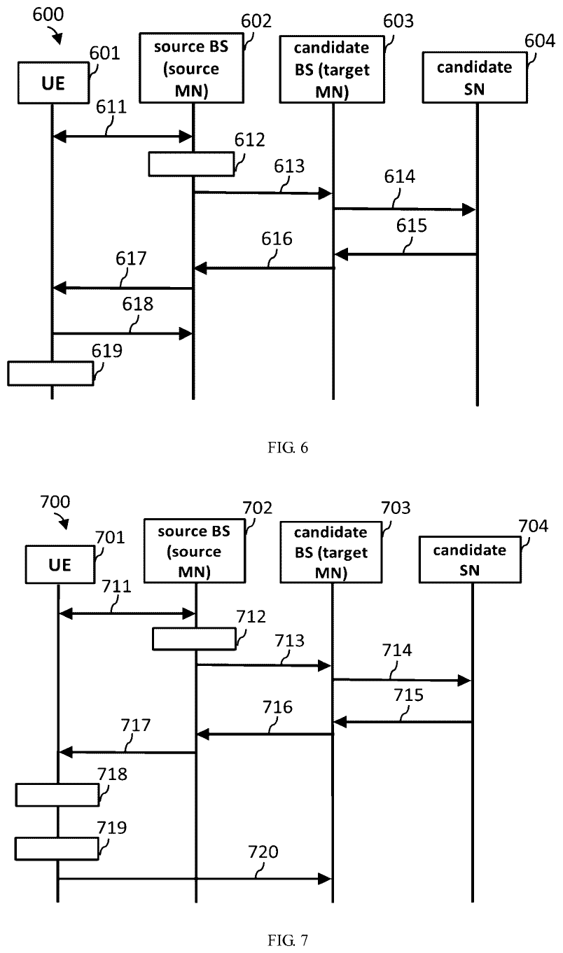

FIG. 5 illustrates an exemplary flowchart of receiving a handover request in accordance with some embodiments of the present application. The exemplary flowchart 500 may be performed by a candidate network node (e.g. a candidate gNB, candidate BS 603, candidate BS 703, or candidate BS 803 as shown and illustrated in any of FIGS. 1 and 6-8). Although described with respect to a candidate network node, it should be understood that other devices may also be configured to perform the exemplary flowchart as shown and illustrated in FIG. 5.

In the exemplary flowchart 500 as shown in FIG. 5, in operation 501, a candidate network node may receive a handover request for a CHO from a source network node. In operation 502, the candidate network node may transmit a response to the source network node. The response may include at least one of the following:
(1) a CHO configuration related to a candidate PCell (e.g. CHO configuration #1 described in the exemplary flowchart 300);
(2) configuration information for one or more candidate SCGs associated with one or more candidate PSCells; and
(3) a set of execution conditions for the one or more candidate SCGs.

In some embodiments of the exemplary flowchart 500, the candidate network node may transmit an indication to the source network node, e.g. via Xn interface. The indication indicates that another CHO configuration (e.g. CHO configuration #2 described in the exemplary flowchart 300) related to the candidate PCell is the same as the CHO configuration related to the candidate PCell in operation 502.

In some embodiments of the exemplary flowchart 500, the candidate network node may receive both a SHR and a SPCR from a UE. The SHR and the SPCR may be simultaneously transmitted by the UE in response to fulfillment of a trigger condition. In some embodiments, the SHR and the SPCR are included in a UE information response message. In some embodiments, in response to fulfillment of the set of execution conditions of multiple SCGs within the one or more candidate SCGs, the UE information response message further includes ID information of other SCGs within the multiple SCGs except one SCG accessed by the UE.

For instance, the trigger condition includes at least one of:
(1) an elapsed time duration of a timer for initiating failure recovery based on triggering measurement report (e.g. timer T312) exceeds a threshold (e.g. threshold #1 described in the exemplary flowchart 300) multiplied by a length of the timer for initiating failure recovery based on triggering measurement report (e.g. timer T312);
(2) an elapsed time duration of a physical layer problem timer (e.g. timer T310) exceeds a threshold (e.g. threshold #2 described in the exemplary flowchart 300) multiplied by a length of the physical layer problem timer (e.g. timer T310); or
(3) an elapsed time duration of a handover timer (e.g. timer T304) exceeds a threshold (e.g. threshold #3 described in the exemplary flowchart 300) multiplied by a length of the handover timer (e.g. timer T304).

In an embodiment, each of threshold #1, threshold #2, and threshold #3 is a percent value of a timer length. Specific examples are described in the embodiments of FIG. 8.

Details described in all other embodiments of the present application are applicable for the embodiments of FIGS. 3-5. Moreover, details described in the embodiments of FIGS. 3-5 are applicable for all the embodiments of FIGS. 1-4 and 6-9.

The following texts describe specific embodiments as shown and illustrated in FIGS. 3-5, in which a UE and network nodes (e.g. a source base station (BS), and candidate BS(s)) perform following operations. It should be appreciated by persons skilled in the art that the sequence of the operations in any of exemplary flowcharts 600, 700, and 800 in FIGS. 6-8 may be changed and some of the operations in any of exemplary flowcharts 600-800 in FIGS. 6-8 may be eliminated or modified, without departing from the spirit and scope of the disclosure.

FIG. 6 illustrates an exemplary flowchart related to a CHO with candidate SCG procedure in accordance with some embodiments of the present application. Details described in all other embodiments of the present application are applicable for the embodiments shown in FIG. 6. The embodiments of FIG. 6 refer to use case #1.

In the exemplary flowchart 600 as shown in FIG. 6, in operation 611, UE 601 in an RRC connected state accesses its serving BS (i.e. serving gNB, e.g. source BS 602). For instance, Dual Connectivity (DC) may be configured for UE 601. In some embodiments, UE 601 may report measurement result(s) to source BS 602 (e.g., source MN 602).

In operation 612, based on the measurement result(s), source BS 602 may determine to switch UE 601 to candidate BS 603 via a CHO.

In operation 613, source BS 602 may transmit a handover request message to candidate BS 603. For instance, source BS 602 may indicate candidate BS 603 to prepare CHO configuration with candidate SCG or CHO configuration without candidate SCG(s).

In operation 614, after receiving the handover request message from source BS 602, candidate BS 603 (as target MN) may transmit a request (e.g. SgNB addition request message or SN modification request message) to candidate SN 604 via Xn interface if candidate BS 603 (i.e. target MN 603) decides to prepare candidate SCG.

In operation 615, candidate SN 604 may transmit an acknowledge message (e.g. SgNB Addition Request Acknowledge or SgNB modification Request Acknowledge) to target MN 603. The CHO configuration(s) for one or more candidate SCGs is included in the acknowledge message.

In operation 616, after receiving the acknowledge message from candidate SN 604, target MN 603 transmits a handover request acknowledge message (i.e. Xn message), which includes the CHO configuration(s) for one or more candidate SCGs, to source BS 602 via Xn interface. For instance, CHO configuration(s) without candidate SCG may also be included in the same Xn message or in a separate Xn message. The execution condition for each candidate SCG may be generated by target MN 603.

In operation 617, after receiving the handover request acknowledge message from target MN 603, source BS 602 transmits an RRC reconfiguration message, which includes the CHO configuration(s) for one or more candidate SCGs, to UE 601. For instance, the corresponding CHO configuration(s) without candidate SCG may be transmitted to UE 601 via the same RRC reconfiguration message or a different RRC reconfiguration message. The corresponding CHO configuration(s) without candidate SCG may include ID information of a target PCell the same as ID information of the target PCell included in the CHO configuration(s) with one or more candidate SCGs.

There may be following two options in different embodiments of the present application, i.e. Option 1 and Option 2.

Option 1: same execution condition(s) may be configured for the CHO configuration(s) without candidate SCG and the CHO configuration(s) with candidate SCG(s).

For example, in Option 1, in operation 617, UE 601 may receive an indication (e.g. indication #1 described in the exemplary flowchart 300) which indicates an association relationship (e.g. a complementary relationship) between the CHO configuration(s) without candidate SCG and the CHO configuration(s) with candidate SCG(s). Then, UE 601 may consider that execution condition(s) for the CHO configuration(s) without candidate SCG is the same as execution condition(s) for the candidate PCell of the CHO configuration(s) with candidate SCG(s).

In an embodiment, an RRC information element (IE) may be as follows, which includes the abovementioned indication (e.g. associatedCondReconfigId as below) and the abovementioned configuration(s) and execution condition(s).

CondReconfigToAddModList information element (IE)

| -- ASN1START | |
|---|---|
| -- TAG-CONDRECONFIGTOADDMODLIST-START | |
| CondReconfigToAddModList-r16 ::= SEQUENCE (SIZE (1.. | |
| maxNrofCondCells-r16)) OF CondReconfigToAddMod-r16 | |
| CondReconfigToAddMod-r16 ::= SEQUENCE { | |
| condReconfigId-r16 | CondReconfigId-r16, |
| associatedCondReconfigId | CondReconfigId |
| condRRCReconfig-r16 | OCTET STRING (CONTAINING |
| RRCReconfiguration) OPTIONAL, -- Cond condReconfigAdd | |
| ..., | |
| [[ | |
| condExecutionCondSCG-r17 | OCTET STRING (CONTAINING |

CondReconfigExecCondSCG-r17) OPTIONAL -- Need M
]]
}
CondReconfigExecCondSCG-r17 ::= SEQUENCE (SIZE (1..2)) OF MeasId
-- TAG-CONDRECONFIGTOADDMODLIST-STOP
-- ASN1STOP

Option 2: different execution conditions may be configured for the CHO configuration(s) without candidate SCG and the CHO configuration(s) with candidate SCG(s), which depends upon the network's implementation.

Referring back to FIG. 6, in operation 618, after receiving the RRC reconfiguration message for the CHO configuration(s) with or without candidate SCG(s) from source BS 602, UE 601 transmits an RRC reconfiguration complete message to source BS 602.

In operation 619, UE 601 starts to evaluate the execution condition(s) for the CHO configuration(s) with candidate SCG(s) and the execution condition(s) for the CHO configuration(s) without candidate SCG.
(1) For example, if UE 601 receives the indication (e.g. indication #1) which indicates an association relationship between the CHO configuration(s) without candidate SCG and the CHO configuration(s) with candidate SCG in operation 617, the execution condition(s) for the CHO configuration(s) with candidate SCG(s) may be the same as or associated with the execution condition(s) for the CHO configuration(s) without candidate SCG.
(2) If the CHO execution conditions of both the CHO with candidate SCG(s) and the CHO without candidate SCG related to the same candidate PCell are fulfilled, a CHO with candidate SCG procedure can be executed if execution condition(s) of a candidate SCG is fulfilled.
(3) If the CHO execution conditions of both the CHO with candidate SCG and the CHO without candidate SCG related to the same target PCell are fulfilled, a CHO without candidate SCG (i.e. CHO-only) can be executed if no execution condition of candidate SCG(s) is fulfilled.

In the exemplary flowchart 600, in some embodiments, in the case that a CHO without candidate SCG is configured to UE 601, the execution conditions for a candidate PCell from the CHO without candidate SCG and a CHO with candidate SCG will be fulfilled at the same time. In this case, if the execution condition of a candidate SCG is also fulfilled, UE 601 may execute the CHO with candidate SCG in priority. If the execution condition of the candidate SCG is not fulfilled yet when the execution conditions for the candidate PCell from the CHO without candidate SCG and a CHO with candidate SCG are fulfilled, UE 601 may not execute CHO-only immediately. Alternatively, one time offset can be configured to the CHO without candidate SCG for UE 601. Namely, if the execution conditions for a candidate PCell from a CHO without candidate SCG and a CHO with candidate SCG are fulfilled at the same time but the execution condition of a candidate SCG is not fulfilled yet, UE 601 needs to wait for a period. If the execution condition of the candidate SCG is still not fulfilled after the period, UE 601 is allowed to execute CHO-only.

FIG. 7 illustrates an exemplary flowchart related to a CHO with candidate SCG procedure in accordance with some embodiments of the present application. Details described in all other embodiments of the present application are applicable for the embodiments shown in FIG. 7. The embodiments of FIG. 7 refer to use case #2.

In the exemplary flowchart 700 as shown in FIG. 7, in operation 711, UE 701 in an RRC connected state accesses its serving BS (i.e. serving gNB, e.g. source BS 702). For instance, Dual Connectivity (DC) may be configured for UE 701. In some embodiments, UE 701 may report measurement result(s) to source BS 702 (e.g., source MN 702).

In operation 712, based on the measurement result(s), source BS 702 may determine to switch UE 701 to candidate BS 703 via a CHO.

In operation 713, source BS 702 may transmit a handover request message to candidate BS 703. For instance, source BS 702 may indicate candidate BS 703 to prepare CHO configuration with candidate SCG or CHO configuration without candidate SCG(s).

In operation 714, after candidate BS 703 receives the handover request message from source BS 702, candidate BS 703 (as target MN) may transmit a request (e.g. SgNB addition request message or SN modification request message) to candidate SN 704 via Xn interface if candidate BS 703 (i.e. target MN 703) decides to prepare candidate SCG.

In operation 715, candidate SN 704 may transmit an acknowledge message (e.g. SgNB Addition Request Acknowledge or SgNB modification Request Acknowledge) to target MN 703. The CHO configuration for one or more candidate SCGs is included in the acknowledge message.

In operation 716, after receiving the acknowledge message from candidate SN 704, target MN 703 transmits a handover request acknowledge message (i.e. Xn message), which includes the CHO configuration(s) for one or more candidate SCGs, to source BS 702 via Xn interface.

In an embodiment, the handover request acknowledge message includes an indication (e.g. indication #4 described in the exemplary flowchart 400), which is used to indicate that a CHO configuration without candidate SCG related to the candidate PCell is the same as CHO configuration(s) (i.e. CHO-only configuration(s)) from the CHO configuration(s) with candidate SCG(s), or indicate that CHO-only configuration(s) from the CHO configuration(s) with candidate SCG(s) can be executed. More specifically, the CIIO-only configuration(s) from the CIIO configuration(s) with candidate SCG(s) can be executed if the execution condition(s) for candidate SCG(s) is not fulfilled.

In operation 717, after receiving the handover request acknowledge message from target MN 703, source BS 702 transmits an RRC reconfiguration message, which includes the CHO configuration(s) for candidate SCG(s), to UE 701.

In an embodiment, the RRC reconfiguration message includes an indication (e.g. indication #2 described in the exemplary flowchart 300), which is used to indicate that a CHO is allowed to be executed by UE 701 based on a CHO configuration without candidate SCG. If this indication is received, UE 701 may consider that the CHO-only configuration(s) related to the candidate PCell may be the same as the CHO configuration(s) related to the candidate PCell for a CHO with candidate SCG procedure. Therefore, in this case, separate configuration(s) for CHO-only can be avoided. This indication may be named as CHO-only indication or the like. UE 701 may execute the CHO-only based on the CHO-only configuration(s).

In a further embodiment, the RRC reconfiguration message includes an indication (e.g. indication #3 described in the exemplary flowchart 300), which is used to indicate that a CHO configuration without candidate SCG related to the candidate PCell is the same as CHO configuration(s) (i.e. CHO-only configuration(s)) from the CHO configuration(s) with candidate SCG(s), or indicate that CHO-only configuration(s) from the CHO configuration(s) with candidate SCG(s) can be executed. More specifically, UE 701 may execute the CHO-only configuration(s) from the CHO configuration(s) with candidate SCG(s) if the execution condition(s) for candidate SCG(s) is not fulfilled. The RRC reconfiguration message may include both indication #2 and indication #3 in some examples.

In another embodiment, UE 701 may also receive the CHO-only configuration(s) which is separate from the CHO configuration(s) from CHO with candidate SCG(s), and then execute the CHO-only based on the CHO-only configuration(s).

In an embodiment, an RRC IE is as follows, which includes the abovementioned indication (e.g. CHOonlyallowed as below) and the abovementioned configuration(s) and execution condition(s).

CondReconfigToAddModList information element

| -- ASN1START | |
|---|---|
| -- TAG-CONDRECONFIGTOADDMODLIST-START | |
| CondReconfigToAddModList-r16 ::= SEQUENCE (SIZE (1.. | |
| maxNrofCondCells-r16)) OF CondReconfigToAddMod-r16 | |
| CondReconfigToAddMod-r16 ::= SEQUENCE { | |
| condReconfigId-r16 | CondReconfigId-r16, |
| condExecutionCond-r16 | SEQUENCE (SIZE (1..2)) OF |
| MeasId | OPTIONAL, -- Need M |
| condRRCReconfig-r16 | OCTET STRING |
| (CONTAINING RRCReconfiguration) | OPTIONAL, -- |
| Cond condReconfigAdd | |
| ..., | |
| [[ | |
| condExecutionCondSCG-r17 | OCTET STRING |
| (CONTAINING CondReconfigExecCondSCG-r17) OPTIONAL -- | |
| Need M | |
| ]] | |
| } | |
| CHOonlyallowed | ENUMERATED {true} |

CondReconfigExecCondSCG-r17 ::= SEQUENCE (SIZE (1..2)) OF
MeasId
-- TAG-CONDRECONFIGTOADDMODLIST-STOP
-- ASN1STOP

If CHO-only is performed, regarding how to handle SCG bearer(s) configured in the candidate SCG(s), there may be different embodiments. In an embodiment, UE 701 can release such SCG bearer(s). In another embodiment, UE 701 can re-map such SCG bearer(s) to MCG bearer(s).

In operation 718, UE 701 starts to evaluate the execution condition(s) for the CHO configuration(s) with candidate SCG(s) and the CHO configuration(s) without candidate SCG (i.e. CHO-only configuration(s)).

In operation 719, UE 701 may perform a CHO with candidate SCG procedure or a CHO-only (i.e. CHO without candidate SCG).

In operation 720, UE 701 may transmit an RRC reconfiguration complete message to target MN 703. There may be following two options in different embodiments, i.e. Option A and Option B.
Option A: the RRC reconfiguration complete message may include an indication to indicate that UE 701 has executed a CHO based on which configuration(s), i.e., based on CHO-only configuration(s) or CHO configuration(s) for the CHO with candidate SCG procedure.
Option B: the RRC reconfiguration complete message includes target PCell ID and/or target PSCell ID, which can be used to indicate whether CHO or CPC is executed by UE 701. For example, if only target PCell ID is included in the RRC reconfiguration complete message, it means that UE 701 has executed CHO-only to the target PCell. If both target PCell ID and target PSCell ID are included in the RRC reconfiguration complete message, it means that UE 701 has executed both CHO to the target PCell and CPC/CPA to the target PSCell.

FIG. 8 illustrates an exemplary flowchart related to a CHO with candidate SCG procedure in accordance with some embodiments of the present application. Details described in all other embodiments of the present application are applicable for the embodiments shown in FIG. 8.

In the exemplary flowchart 800 as shown in FIG. 8, in operation 811, UE 801 in an RRC connected state accesses its serving BS (i.e. serving gNB, e.g. source BS 802). For instance, Dual Connectivity (DC) may be configured for UE 801. In some embodiments, UE 801 may report measurement result(s) to source BS 802 (e.g., source MN 802).

In operation 812, based on the measurement result(s), source BS 802 may determine to switch UE 801 to candidate BS 803 via a CHO.

In operation 813, source BS 802 may transmit a handover request message to candidate BS 803. For instance, source BS 802 may indicate candidate BS 803 to prepare CHO configuration with candidate SCG or CHO configuration without candidate SCG.

In operation 814, candidate BS 803 transmits a handover request acknowledge message (i.e. Xn message), which includes CHO configuration(s) for one or more candidate SCGs, to source BS 802 via Xn interface. For instance, CHO configuration(s) without candidate SCG may be included in the same Xn message or in a separate Xn message. The execution condition for each candidate SCG may be generated by candidate BS 803 (may also be named as target MN 803).

In operation 815, after receiving the handover request acknowledge message from candidate BS 803, source BS 802 transmits an RRC reconfiguration message, which includes the CHO configuration(s) for one or more candidate SCGs, to UE 801. For instance, the corresponding CHO configuration(s) without candidate SCG may be transmitted to UE 801 via the same RRC reconfiguration message or a different RRC reconfiguration message. The corresponding CHO configuration(s) without candidate SCG may have ID information of target PCell the same as the ID information of target PCell included in the CHO configuration(s) with one or more candidate SCGs.

In an embodiment, the RRC reconfiguration message includes a trigger condition, which is for triggering simultaneous transmission of both CHO related information and CPC related information (e.g. a SHR and a SPCR). For instance, a new single threshold for timer T312, timer T311, or timer T304 for both PCell and PSCell may be included in the RRC reconfiguration message. The threshold may be threshold #1, threshold #2, or threshold #3 as described in the exemplary flowchart 300. The threshold may be a percent value of a timer length. In one example, the threshold can be applied to both PCell change and PSCell change executed by UE 801. Once the threshold is triggered for PCell change or PSCell change, both CHO related information and CPC related information (e.g. a SHR and a SPCR) may be reported by UE 801.

In operation 816, after receiving the RRC reconfiguration message for the CHO configuration(s) with or without candidate SCG(s) from source BS 802, UE 801 transmits an RRC reconfiguration complete message to source BS 802.

In operation 817, UE 801 starts to evaluate execution condition(s) for the CHO configuration(s) and execution condition(s) for candidate SCG(s).

In operation 818, UE 801 executes a CHO with one candidate SCG, i.e. both PCell change and PSCell change. After UE 801 successfully accesses a target PCell and a target PSCell, a SHR and a SPCR may be triggered based on the following condition.
(1) an elapsed time duration of T312 exceeds a threshold (e.g. threshold #1) multiplied by a length of T312;
(2) an elapsed time duration of T310 exceeds a threshold (e.g. threshold #2) multiplied by a length of T310; or
(3) an elapsed time duration of T304 exceeds a threshold (e.g. threshold #3) multiplied by a length of T304.

In operation 819, UE 801 transmits an RRC message including an indication (e.g. an available indication) to candidate BS 803 (i.e. target MN 803), to indicate that a SHR and/or a SPCR is available.

In operation 820, target MN 803 may transmit a UE information request message to UE 801 based on the available indication. The UE information request message may include the SHR and/or the SPCR.

In operation 821, UE 801 transmits a UE information response message to target MN 803. For instance, the UE information response message may include the SHR and the SPCR. In addition, in an embodiment, UE 801 selects one SCG among multiple suitable SCGs and executes a CHO with the selected one SCG. Therefore, whether execution condition(s) of other SCG(s) within multiple suitable SCGs is fulfilled can be reported. Thus, the UE information response message may further include whether the execution condition(s) of other SCG(s) within multiple suitable SCGs except the selected SCG is fulfilled.

In operation 822, target MN 803 will transfer the received report from UE 801 to source MN 802.

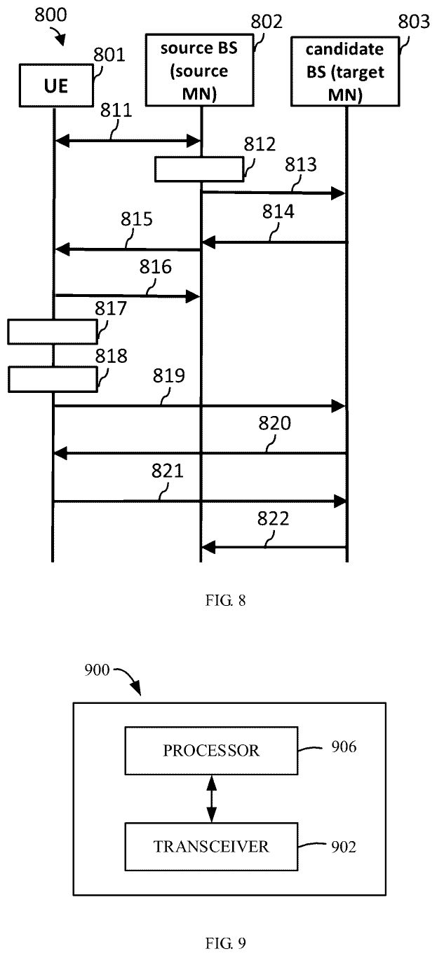

FIG. 9 illustrates an exemplary block diagram of an apparatus in accordance with some embodiments of the present application. As shown in FIG. 9, the apparatus 900 may include at least one processor 904 and at least one transceiver 902 coupled to the processor 904. The apparatus 900 may be a UE or a network node (e.g. a source network node, or a candidate network node).

Although in this figure, elements such as the at least one transceiver 902 and processor 904 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may further include at least one non-transitory computer-readable medium. In some embodiments of the present disclosure, the non-transitory computer-readable medium may have stored thereon computer-executable instructions to cause a processor to implement the method with respect to a UE or a network node (e.g. a source BS or a candidate BS) as described above. For example, the computer-executable instructions, when executed, cause the processor 904 interacting with transceiver 902, so as to perform operations of the methods, e.g. as described in view of any of FIGS. 3-8.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive first radio resource control (RRC) configuration information for a conditional handover (CHO) with candidate secondary cell groups (SCG)s for conditional primary secondary cell group cell (PSCell) change (CPC)/conditional PSCell addition (CPA) procedure; and
access a candidate primary cell (PCell) based on the first RRC configuration information.

2. The UE of claim 1, wherein the first RRC configuration information includes:
a first CHO configuration related to the candidate PCell;
a first CHO execution condition for the candidate PCell;
configuration information for one or more candidate SCGs associated with one or more candidate PSCells; and
a set of execution conditions for the one or more candidate SCGs.

3. The UE of claim 2, wherein the at least one processor is configured to cause the UE to receive second RRC configuration information for a second CHO configuration without candidate SCG.

4. The UE of claim 3, wherein a second CHO execution condition is configured for the second CHO configuration.

5. The UE of claim 3, wherein the second RRC configuration information includes a first indication indicating an association relationship between the second CHO configuration and the first CHO configuration.

6. The UE of claim 5, wherein in response to receiving the first indication, the at least one processor is configured to cause the UE to consider that a second CHO execution condition for the second CHO configuration is a same CHO execution condition as the first CHO execution condition for the candidate PCell.

7. The UE of claim 4, wherein in response to fulfillment of both the second CHO execution condition for the second CHO configuration and the first CHO execution condition for the first CHO configuration, the at least one processor is configured to cause the UE to:
in response to fulfillment of the set of execution conditions for one candidate SCG within the one or more candidate SCGs, execute a CHO based on the first CHO configuration to both the candidate PCell and one candidate PSCell associated with the one candidate SCG.

8. The UE of claim 2, wherein the at least one processor is configured to cause the UE to receive at least one of:
a first indication that a CHO is allowed to be executed by the UE based on a second CHO configuration without candidate SCG; or
a second indication that the second CHO configuration without candidate SCG related to the candidate PCell is a same CHO configuration as the first CHO configuration related to the candidate PCell.

9. The UE of claim 8, wherein in response to receiving at least one of the first indication or the second indication, the at least one processor is configured to cause the UE to consider that the second CHO configuration is the same CHO configuration as the first CHO configuration.

10. The UE of claim 8, wherein in response to unfulfillment of the set of execution conditions for the one or more candidate SCGs and fulfillment of the first CHO execution condition, the at least one processor is configured to cause the UE to access the candidate PCell based on the second CHO configuration.

11. The UE of claim 10, wherein after successfully accessing the candidate PCell based on the second CHO configuration, the at least one processor is configured to cause the UE to:
release one or more SCG bearers configured in the one or more candidate SCGs; or
re-map the one or more SCG bearers to a master cell group (MCG) bearer configured in the candidate PCell.

12. The UE of claim 9, wherein the at least one processor is configured to cause the UE to:
execute a CHO based on the first CHO configuration or the second CHO configuration; and
after successfully accessing the candidate PCell, transmit an RRC reconfiguration complete message to the candidate PCell.

13. The UE of claim 12, wherein the RRC reconfiguration complete message includes an indication that the UE has executed a CHO based on which one of the first CHO configuration and the second CHO configuration.

14. A source network node, comprising:
at least one memory; and
at least one processor coupled with the at least one memory and configured to cause the source network node to:
transmit a handover request for a conditional handover (CHO); and
receive a response from a candidate network node, wherein the response includes:
a first CHO configuration related to a candidate primary cell (PCell); and
configuration information for one or more candidate secondary cell groups (SCG)s associated with one or more candidate primary secondary cell group cells (PSCell)s.

15. A candidate network node, comprising:
at least one memory; and
at least one processor coupled with the at least one memory and configured to cause the candidate network node to:
receive a handover request for a conditional handover (CHO) from a source network node; and
transmit a response to the source network node, wherein the response includes:
a first CHO configuration related to a candidate primary cell (PCell); and
configuration information for one or more candidate secondary cell groups (SCG)s associated with one or more candidate primary secondary cell group cells (PSCell)s.

16. A method performed by a user equipment (UE), the method comprising:
receiving first radio resource control (RRC) configuration information for a conditional handover (CHO) with candidate secondary cell groups (SCG)s for conditional primary secondary cell group cell (PSCell) change (CPC)/conditional PSCell addition (CPA) procedure; and
accessing a candidate primary cell (PCell) based on the first RRC configuration information.

17. The method of claim 16, wherein the first RRC configuration information includes:
a first CHO configuration related to the candidate PCell;
a first CHO execution condition for the candidate PCell;
configuration information for one or more candidate SCGs associated with one or more candidate PSCells; and
a set of execution conditions for the one or more candidate SCGs.

18. The method of claim 17, further comprising receiving second RRC configuration information for a second CHO configuration without candidate SCG.

19. The method of claim 18, wherein a second CHO execution condition is configured for the second CHO configuration.

20. The method of claim 19, wherein in response to fulfillment of both the second CHO execution condition for the second CHO configuration and the first CHO execution condition for the first CHO configuration, the method further comprises:
in response to fulfillment of the set of execution conditions for one candidate SCG within the one or more candidate SCGs, executing a CHO based on the first CHO configuration to both the candidate PCell and one candidate PSCell associated with the one candidate SCG.
